(19) United States
(12) Patent Application Publication
(10) Pub. No.: US 2023/0213346 A1
(43) Pub. Date: Jul. 6, 2023

(54) SOLVING ROUTING PROBLEMS USING MACHINE LEARNING

(71) Applicant: MICROSOFT TECHNOLOGY LICENSING, LLC, Redmond, WA (US)

(72) Inventors: Kartavya NEEMA, San Ramon, CA (US); Amir Hossein JAFARI, Emeryville, CA (US); Brice Hoani Valentin CHUNG, Oakland, CA (US); Aydan AKSOYLAR, San Mateo, CA (US); Hossein Khadivi HERIS, Berkeley, CA (US)

(21) Appl. No.: 17/565,964

(22) Filed: Dec. 30, 2021

(51) Int. Cl. G01C 21/34

(52) U.S. Cl. CPC G01C 21/343

(57) ABSTRACT

The techniques disclosed herein enable systems to solve routing problems using machine learning augmented by optimization modules. To plot a route, a system receives a plurality of nodes from a problem space. The plurality of nodes is then analyzed by an optimization module and ranked based on various criteria such as distance from a reference node and deadline. Based on the ranking, the optimization module can select a smaller subset of nodes that is then processed by a machine learning model. The machine learning model can then select a node from the subset of nodes for addition to a route. This process can be repeated until a route is plotted for the full set of nodes within the problem space. In addition, the system can be configured to monitor current conditions of the problem space to modify the route in response to changes.

### BACKGROUND

As modern systems and organizations expand to a global scale, various management problems similarly grow in scale. For example, any enterprise that is involved in manufacturing and/or e-commerce must contend with significant challenges in supply chain and fulfillment logistics. Naturally, as the business grows over time these challenges can balloon in complexity. In another example, telecommunications systems must contend with similar challenges as transmitting data through a large network comprising thousands or even millions of devices can bear a resemblance to these logistical issues. A common element among these disparate applications is often routing problems that can involve many destinations (also called nodes), impending deadlines, shifting topologies, and the like. For instance, in large scale operations, nodes can number in the hundreds or even thousands. In addition, visits to these nodes must typically occur within a time window and with short notice such as an urgent delivery. As such, to plan an optimal route, one must account for a wide variety of factors that would easily overwhelm any manual methods.

To quickly plan optimal routes, many organizations have turned to automated approaches to handle the massive amounts of data and analysis required for large graph-based routing problems. Specifically, significant effort has been dedicated to developing optimization techniques that provide optimal solutions for a full problem space such as branch and bound methods and genetic algorithms. However, the time required to solve a routing problem can increase exponentially with the number of nodes. Stated another way, routing problems become disproportionately more complex as the size of the problem space increases. As such, many existing techniques are unable to provide an adequate solution to large routing problems in a reasonable amount of time.

In addition, typical optimization techniques can be effective in static environments where no nodes are added or removed and where travel conditions remain consistent. However, systems that aim to solve real-world routing problems must account for a constantly changing environment. For instance, in a logistics context, a sudden change in deadline may require recalculation of the route in real time while inclement weather can affect travel times between nodes. In another example, a delivery may be cancelled which eliminates a node from the problem space while a new delivery is ordered, which adds a node. In these examples, traditional optimization methods do not effectively adjust to the dynamic conditions of real-world applications without also incurring significant or even infeasible additional computational cost.

As mentioned, typical approaches for solving routing problems can oftentimes prove inflexible to various constraints that arise in real-world applications such as changes to deliveries and shifting deadlines. In this way, many existing routing systems can provide unrealistic or unsatisfactory results leading to a degraded experience for customers and partners alike. Thus, there is a need for systems that can effectively handle large routing problems to improve efficiency and provide excellent service.

It is with respect to these and other considerations that the disclosure made herein is presented.

### SUMMARY

The disclosed techniques improve the functionality of systems for solving routing problems through the introduction of an optimization module working in conjunction with a machine learning model. Generally described, a system receives a plurality of nodes which collectively form a graph or problem space. In various examples, the nodes can number in the hundreds or even thousands. The optimization module selects a subset of nodes from the overall problem space which is then provided to the machine learning model to generate a route.

While many of the examples discussed herein are described with respect to delivery vehicles that visit various towns and cities, it is understood in the context of this disclosure that the techniques can solve routing problems in any other context. For instance, the disclosed system can be applied to routing data in a telecommunications network.

As will be elaborated upon further below, the system can utilize an optimization module to select subsets of nodes from a large problem space comprising many nodes. Stated another way, the optimization module can break a large problem space down into small portions which can be quickly processed by a machine learning model. For instance, for a problem space having one hundred nodes, the optimization module may be configured to select five nodes for each subset. In some examples, the optimization module can be a heuristic that ranks nodes based on distance and deadline to ensure that high priority nodes are routed and visited first. It should be understood that any suitable approach can be used to configure the optimization module such as various priorities and factors as well as other optimization algorithms as opposed to a heuristic.

Once the subset of nodes is selected by the optimization module, a machine learning model can then analyze the subset and select a node to add to a route. For instance, the system may be configured with a starting reference node. Based on the position of the starting reference node within the problem space, the optimization module can select a subset of nodes for the machine learning model. Accordingly, the machine learning model can select a node from the subset as a destination thereby beginning the route. This process can then be repeated for each subsequent node to plot a route for the full problem space. In various implementations, the machine learning model can utilize a reinforcement learning approach. However, it should be understood that any suitable method can be utilized for the machine learning model to select nodes for a route.

In contrast to typical methods for solving routing problems, the techniques disclosed herein can analyze and process a problem space comprising a large number of nodes (e.g., one hundred nodes, one thousand nodes, etc.). As mentioned above, many practical applications of routing problems can involve hundreds and even thousands of nodes. For existing solutions, generating a route for such large problem spaces can consume an inordinate amount of time and computing resources to generate a first feasible solution much less an optimal one. Conversely, by utilizing an optimization module to select a smaller subset of nodes from the overall problem space, the disclosed system can intelligently narrow the range of decisions that a machine learning model must consider. In this way, the disclosed system conserves computing resources while ensuring a realistic and efficient final route. In addition, by approaching a routing problem in a piecewise fashion the disclosed techniques enable systems to generate realistic and feasible routes in a reasonable timeframe.

Furthermore, as mentioned above, many existing methods for solving routing problems can be highly inflexible and cannot account for many of the unexpected changes that arise in practical applications. In contrast, the disclosed system can adapt to constantly changing conditions such as addition and deletion of nodes, travel time, and deadlines. For instance, while some existing optimization solutions can be effective for solving routing problems for a static set of nodes, addition or deletion of nodes cannot be captured by these methods. As a result of this inflexibility, existing solutions may require full recalculation of the route in the event of an addition or deletion of a node thereby further consuming time and computing resources. By augmenting a machine learning model with an optimization module, the disclosed system can seamlessly address these challenges. For example, as will be discussed below, the optimization module can rank nearby nodes based on distance and a configured deadline.

In another example, a well-known shortcoming of various existing approaches that directly apply machine learning models to route calculation is a tendency to select nodes that have already been routed. Often referred to as a travelling salesperson problem, routing the same node multiple times can be undesirable as this may reduce the optimality of the overall route. In contrast, as will be discussed below, the optimization module can receive data defining the current state of the problem space and track which nodes have already been routed. Accordingly, the optimization module can curate nodes such that the machine learning model does not route a node more than once thereby preventing repeat visits in the final route. In this way, the disclosed system enables the use of machine learning models for solving routing problems thereby enhancing the performance of routing systems while maintaining high quality and efficient routes.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for solving routing problems using an optimization module and machine learning model.

FIG. 2A illustrates a first state of an example routing problem involving a plurality of cities spread around a geographic area.

FIG. 2B illustrates a second state of the example routing problem involving a plurality of cities spread around a geographic area.

FIG. 2C illustrates a third state of the example routing problem involving a plurality of cities spread around a geographic area.

FIG. 2D illustrates the example routing problem in which a travelling entity traverses the route plotted by the system.

FIG. 2E illustrates another state of the example routing problem in which the travelling entity encounters an unexpected change to the travel itinerary.

FIG. 2F illustrates another example of an unexpected change to the travel itinerary.

FIG. 2G illustrates yet another example of an unexpected change to the travel itinerary.

FIG. 3 is a block diagram showing various aspects of an individual node.

FIG. 4 is a block diagram showing various aspects of the optimization module.

FIG. 5 is a block diagram showing various aspects of the machine learning model.

FIG. 6 is a flow diagram showing aspects of a routine for solving routing problems using an optimization module and machine learning model.

FIG. 7 is a computer architecture diagram illustrating an illustrative computer hardware and software architecture for a computing system capable of implementing aspects of the techniques and technologies presented herein.

FIG. 8 is a diagram illustrating a distributed computing environment capable of implementing aspects of the techniques and technologies presented herein.

### DETAILED DESCRIPTION

The techniques described herein provide systems for optimizing the use of computing resources by the introduction of an optimization module to augment a machine learning model for plotting routes in a problem space comprising many nodes. As mentioned above, in many practical applications, routing problems can involve hundreds and even thousands of nodes which can range from delivery destinations to devices in a telecommunications network. Individual nodes can also be configured with a deadline indicating a time window in which the node must be visited. In addition, nodes can be added and removed from the problem space in response to changing conditions. For instance, inclement weather may prevent completion of a delivery which causes a deletion of the corresponding node. In another example, a customer may request an urgent delivery resulting in a new node being added to the problem space with a corresponding deadline.

The disclosed techniques address several technical problems associated with systems for solving routing problems. For example, in large routing problems involving many nodes where time complexity increases exponentially with the number of nodes, existing approaches can fail to provide an adequate solution in a reasonable timeframe. In contrast, the disclosed system, through the optimization module, can plot efficient and effective routes for large problems in much less time in comparison to existing routing methods. In various examples, the optimization module can be an optimizer or a heuristic that represents a significant reduction in computational cost in comparison to existing optimization methods. In this way, the disclosed system addresses the prohibitive complexity of large routing problems while harnessing the many benefits of a machine learning model-based approach.

By implementing the optimization module in conjunction with a machine learning model, the disclosed techniques enable several crucial technical benefits in addition to the increased processing speed mentioned above. For example, many existing solutions focus largely on plotting an optimal route and cannot account for various time dependent constraints such as impending deadlines. As such, routes plotted using traditional methods can prove impractical for fulfilling real-world needs and can lead to a degraded experience. Conversely, as will be elaborated upon below, the disclosed system can account for time constraints through the optimization module. The optimization module can rank nodes based on a distance from a reference node as well as a deadline associated with each node. In this way, the resultant route can be more practically realistic in comparison to typical methods.

In another example of the technical benefit of the present disclosure, the optimization module enables the system to account for unexpected changes that may occur while traversing a route. Consider for example, a logistics company that is responsible for making deliveries to various cities or towns (e.g., ones that are in close proximity to one another, ones that are far away from one another, etc.). In real-world applications deliveries may be cancelled resulting in a node deletion from the problem space. Alternatively, other deliveries may be requested on short notice resulting in a sudden node addition to the problem space. In typical systems, these additions and deletions can require a complete recalculation of the route leading to reduced performance and potential delays. In contrast, by utilizing an optimization module to receive data on the current state of the problem space, the disclosed system can quickly detect changes and adjust routing accordingly thereby conserving computing resources and improving overall route quality.

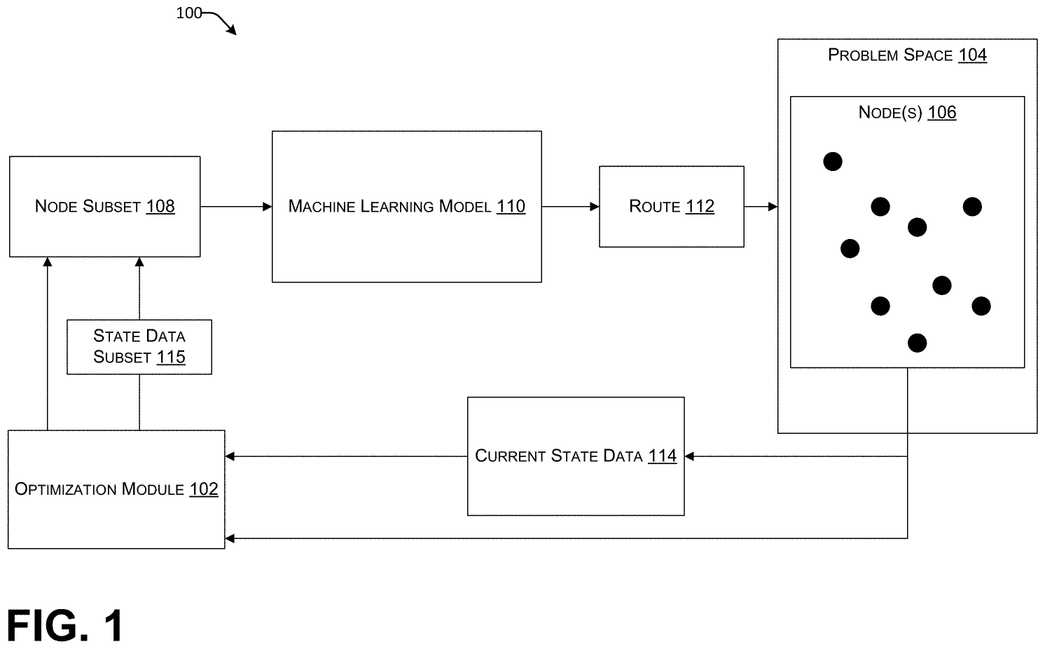

Various examples, scenarios, and aspects that enable route problem solving through machine learning and optimization modules are describe below with reference to FIGS. 1-8.

FIG. 1 illustrates an example system 100 in which an optimization module 102 analyzes a problem space 104 comprising a plurality of nodes 106. As will be described further below, the optimization module 102 can utilize various criteria to rank various nodes 106 based on their relation to a reference node. For example, a reference node can be a starting location for planning a route such as a distribution center for a logistics company. Based on the ranking, the optimization module 102 can select a node subset 108 from the nodes 106. In various examples, the node subset 108 can comprise a smaller number of nodes in comparison to the full set of nodes 106 in problem space 104. For example, nodes 106 may contain one hundred individual nodes while node subset 108 can contain five nodes. It should be understood that individual nodes can correspond to any suitable object such as a physical location (e.g., a county, a city, a town, a neighborhood, an individual street address for a home, office, or retail store, etc.) or a virtual location such a computing device in a network, and so forth.

The node subset 108 can be subsequently provided to machine learning model 110 for processing. As mentioned above, by providing the machine learning model 110 with the node subset 108 rather than the full problem space 104, the system 100 can dramatically reduce processing times in comparison to typical systems. As with the optimization module 102, the machine learning model 110 can be configured with a reference node. Accordingly, the machine learning model 110 can then select a node from the node subset 108 that is most optimal based on its position relative to the reference node. In some examples, this can be a shortest distance between two nodes. Alternatively, the machine learning model 110 may be configured with travel times between nodes that may differ from an absolute distance. Once the machine learning model 110 has selected a node from node subset 108, the node can be added to route 112, at which point the selected node can become the new reference node. This process can then be reiterated until a route 112 is plotted for the full set of nodes in problem space 104.

Furthermore, as mentioned above, the optimization module 102 as well as the machine learning model 110 can be configured to extract current state data 114 from the problem space 104. The current state data 114 can define various conditions of problem space 104 such as addition or deletion of nodes, current travel conditions, shifting deadlines, and the like. In this way, the route 112 can be adapted and modified in real-time in response to changing conditions defined by current state data 114. In a specific example, inclement weather may drastically slow down travel times to various nodes 106. As will be discussed in greater detail below, this shift in conditions can be captured and reported by current state data 114 and accounted for by optimization module 102, and subsequently machine learning model 110.

In addition, the optimization module 102 can utilize the current state data 114 to further refine the generation of the node subset 108. As mentioned above, while the optimization can consider distance relative to a reference node as well as deadline when selecting nodes, other uncertain factors can also affect the route 112. As such, the optimization module 102 can utilize a state data subset 115 that is extracted from current state data 114 to augment the node subset 108. For instance, inclement weather may affect travel times within the nodes 106 of the problem space 104. To account for shifting conditions, the optimization module 102 may include weather data as part of the state data subset 115 when generating the node subset 108.

In another example, the optimization module 102 can provide the state data subset 115 to the machine learning model 110 as part of the node subset 108. For instance, in a node subset 108 that is generated based only on distance and deadline, a particular node 106 may be highly ranked due to a short distance to a reference node in relation to other nodes 106. However, current traffic conditions may drastically extend travel time from the reference node to that particular node 106. This information can be captured as part of the state data subset 115 and reflected in a modified ranking of the particular node 106 within the node subset 108. It should be understood that any relevant information regarding conditions within the problem space 104 can be captured within the current state data 114 and that a portion of the information can be reflected in the state data subset 115.

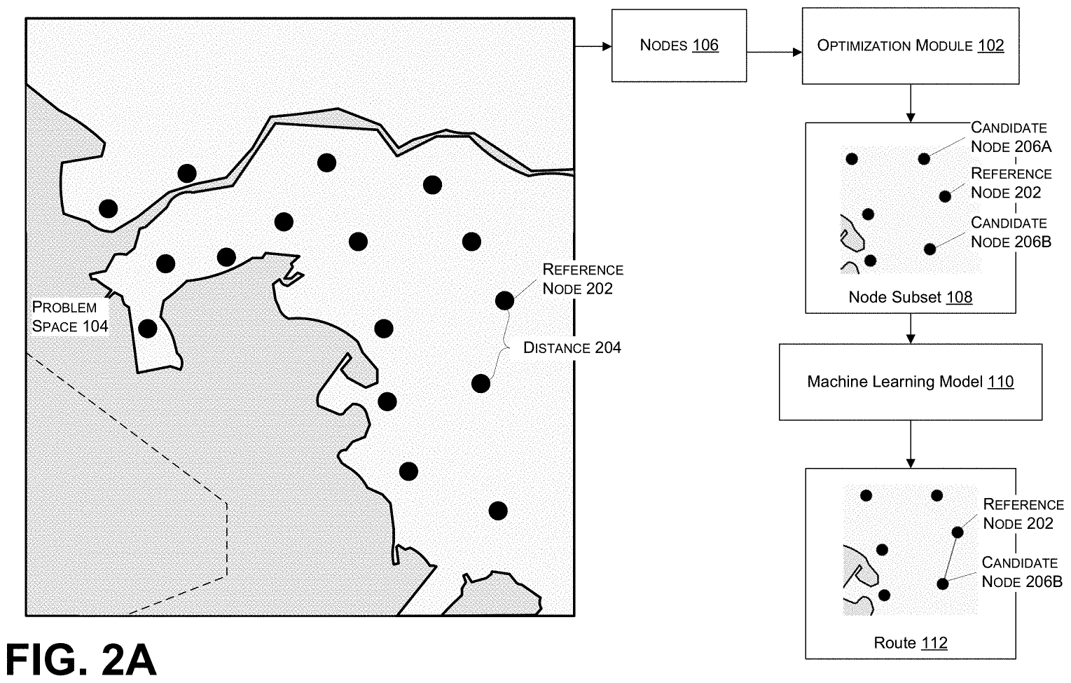

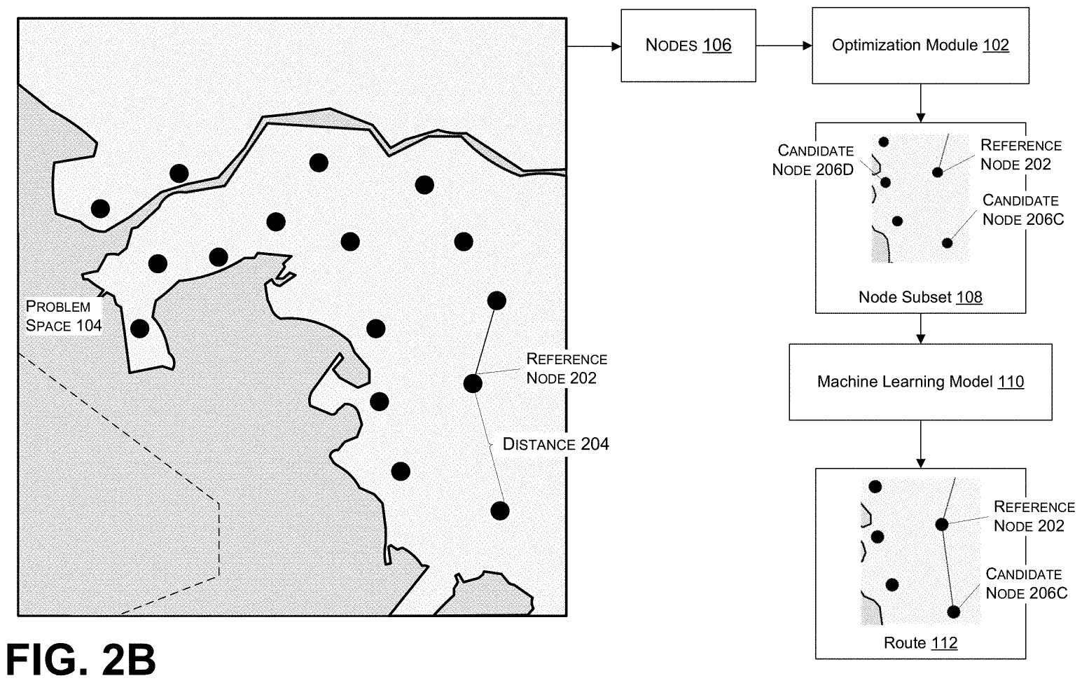

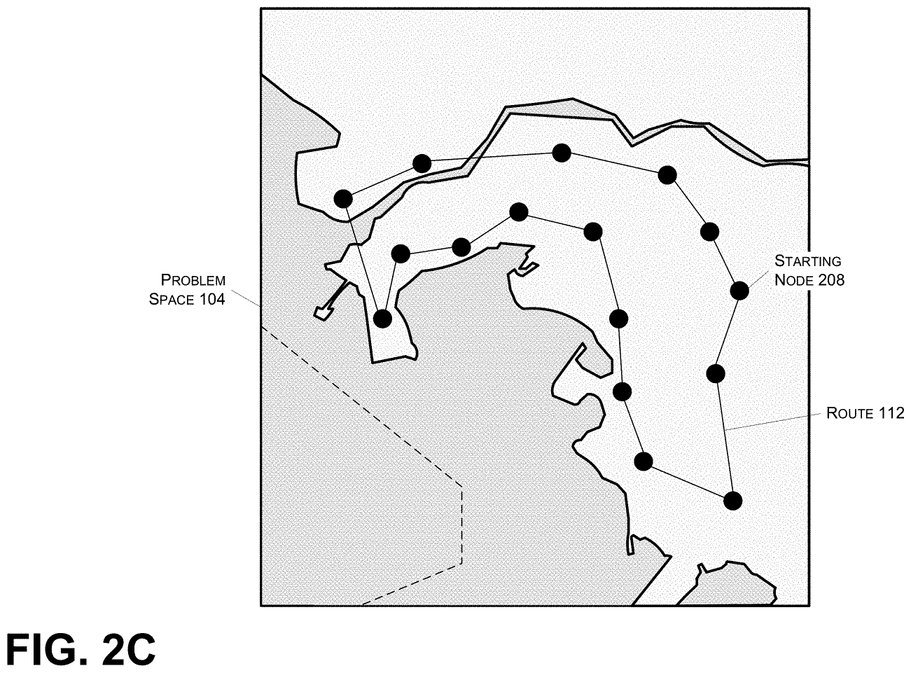

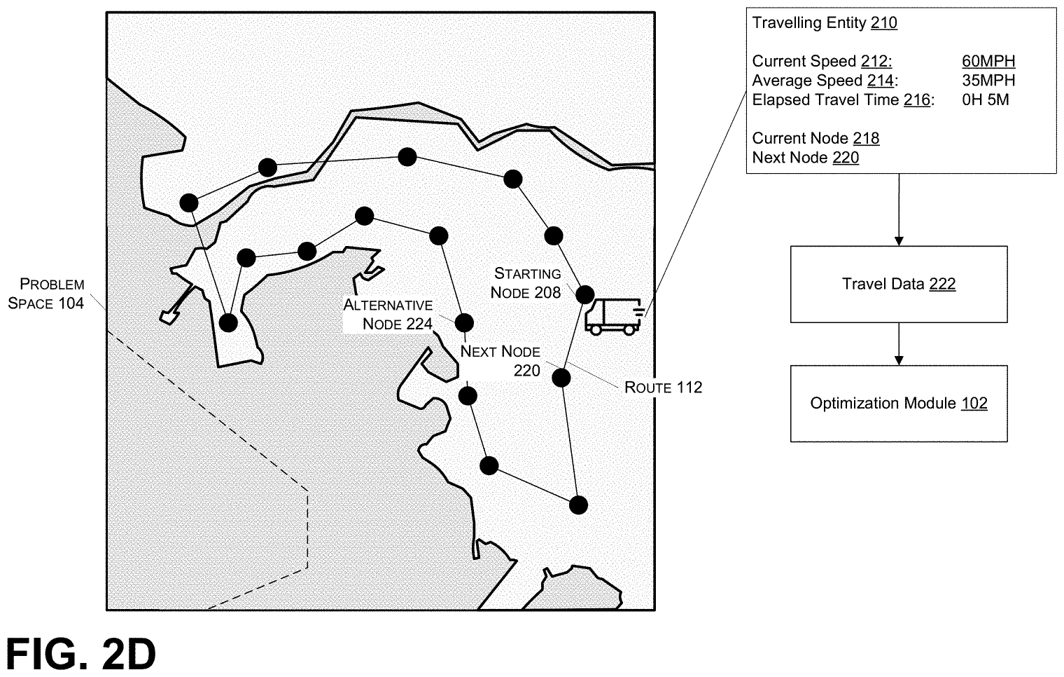

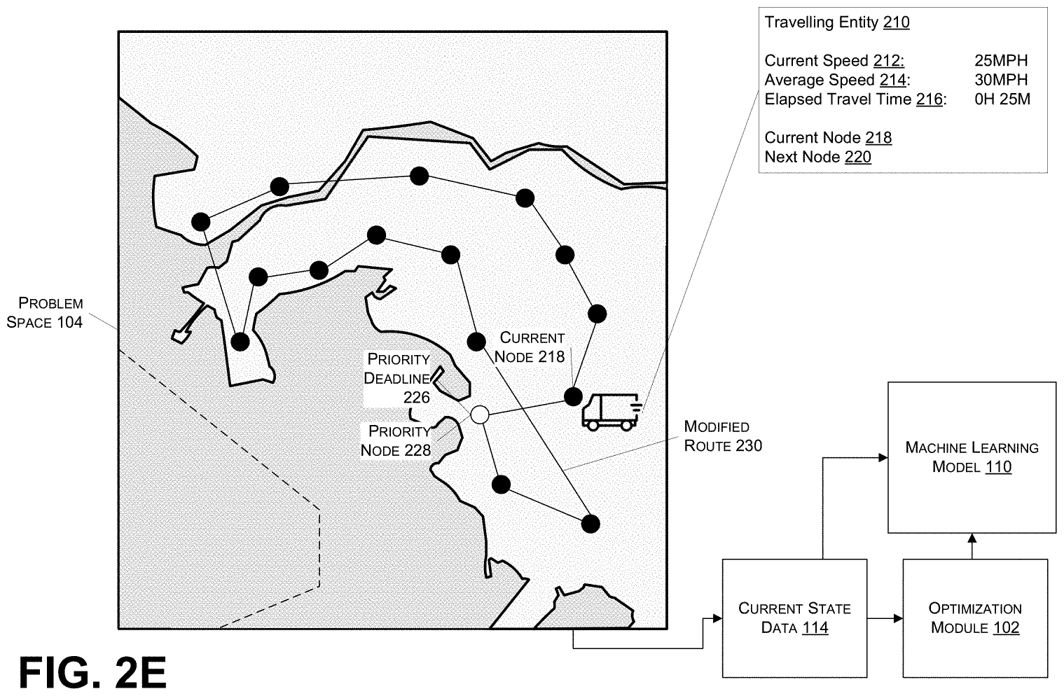

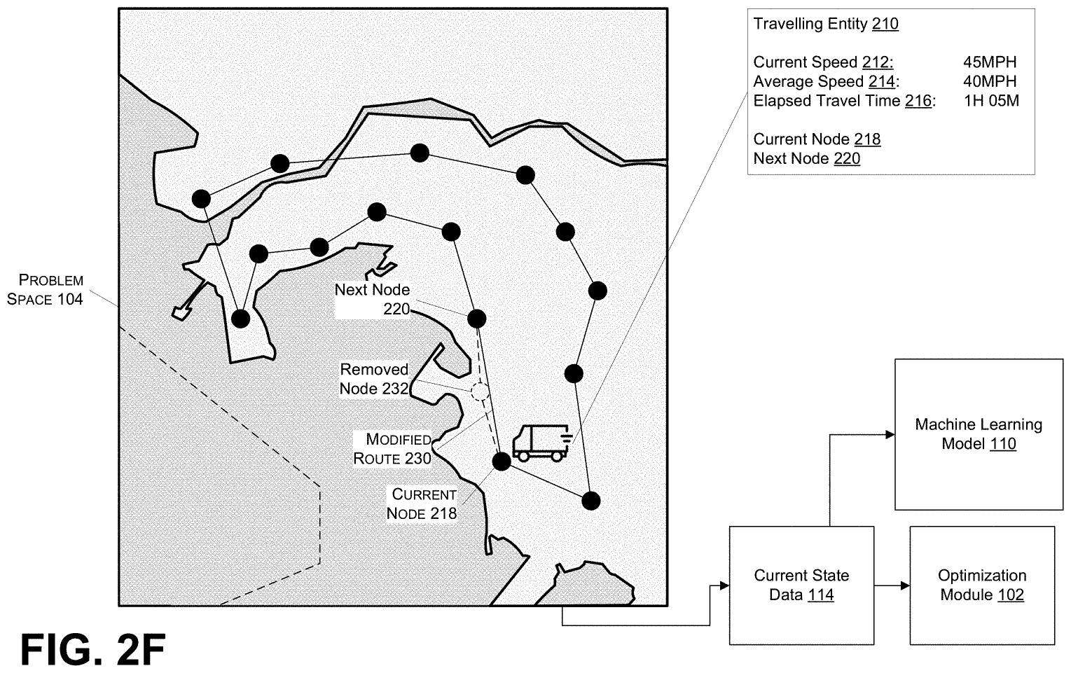

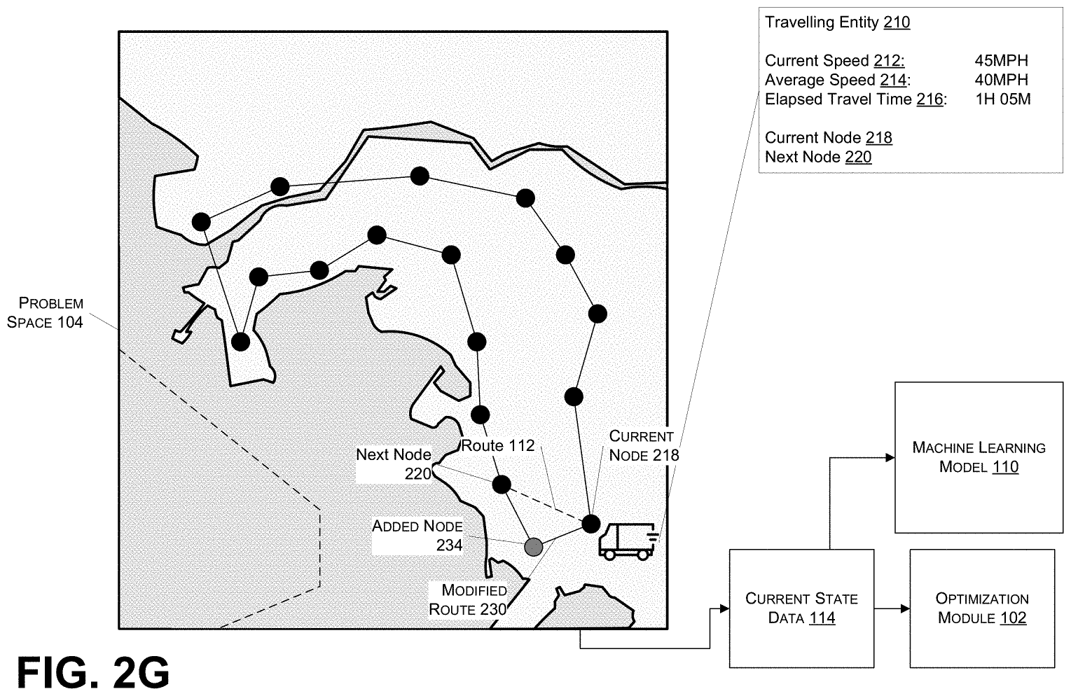

Turning now to FIG. 2A, aspects of an example application of the system 100 are shown and described. As illustrated in FIG. 2A, the problem space 104 comprises a map with several nodes 106 (e.g., the large black dots) spread around a geographic area. As mentioned above, individual nodes 106 can correspond to a physical location such as a city, a specific address, and so forth. In addition, a reference node 202 can be configured for the problem space 104 to provide a starting point for plotting route 112. Accordingly, the plurality of nodes within problem space 104 can be provided to an optimization module 102 for analysis.

Based on various factors such as a distance 204 to the reference node 202, travel time to other nodes 106, deadlines, and the like, the optimization module 102 can generate a ranked list of the nodes 106. The ranked list can be used by optimization module 102 to determine a node subset 108 that is provided to the machine learning model 110. In a specific example, optimization module 102 may be configured to generate a ranked list of all the nodes 106 based on their distance 204 to the reference node 202 and then select a top number of nodes from the list (e.g., five nodes 106). For instance, as shown in FIG. 2A, the optimization module 102 selects five candidate nodes 206 from the full set of nodes 106. It should be understood that optimization module 102 may be configured to select any number of candidate nodes 206 to suit various applications or machine learning models 110. In addition, while only some of the illustrated nodes of the node subset 108 are explicitly labelled as candidate nodes 106, it should be understood that all nodes of node subset 108 aside from the reference node 202 can be candidate nodes 206.

In other implementations, optimization module 102 may dynamically adjust the number of nodes 106 that are selected for node subset 108. For instance, the optimization module 102 may be configured with various thresholds that can be used to determine whether a node 106 can be selected for the node subset 108. In a specific example, the optimization module 102 can consider a distance threshold. If the distance 204 from a certain node 106 to the reference node 202 exceeds the distance threshold, the node 106 can then be rejected by optimization module 102 from the node subset 108. As will be shown below with respect to FIG. 2B, this may result in a node subset 108 that includes fewer nodes 106 than the default number. In some examples, optimization module 102 may also select more than the default number of nodes 106 where several nodes 106 satisfy the various thresholds. However, optimization module 102 can be configured with a maximum size for node subset 108 so as to maintain a certain level of performance of the machine learning model 110.

Once the optimization module 102 has selected candidate nodes 206 for node subset 108, machine learning model 110 can proceed to analyze the node subset 108 and begin constructing a route 112. In a specific example, the machine learning model 110 may be configured with the distances from the reference node 202 to the various candidate nodes 206. Accordingly, the machine learning model 110 may simply select the candidate node 206A with the shortest distance to the reference node 202. In another example, machine learning model 110 may also configured with historical data from past routes 112 such as travel times and traffic flow. Based on the historical data the machine learning model 110 may determine that, while the distance to candidate node 206A is shorter than the distance to candidate node 206B, it is less optimal in comparison to candidate node 206B for route 112.

In another example, the machine learning model 110 can be applied to a problem space 104 within a simulator to learn the best routing strategy for a given problem space 104. For instance, the simulator can provide the machine learning model 110 with a set of nodes 106 to analyze. In various configurations, the problem space 104 can include a large set of nodes 106 that resembles a real-life scenario. Through many iterations, the machine learning model 110 can learn and understand the impact of various decisions on the optimality of the route 112. In this way, the machine learning model 110 can iteratively improve over time to uncover more optimal routing strategies. It should be understood that the machine learning model 110 can be implemented using any suitable machine learning techniques such as reinforcement learning, supervised learning and unsupervised learning.

Upon selecting a candidate node 206B, the candidate node 206B can be added to the route 112. As mentioned above, candidate node 206B can now become a new reference node 202 and the process as described above can be repeated. For example, as shown in FIG. 2B, what was previously candidate node 206B, is now reference node 202. Accordingly, the optimization module 102 can select a new node subset 108 based on the location of reference node 202 within the problem space 104. As mentioned above, the size of node subset 108 can fluctuate based on a threshold distance 204 of reference node 202 to other nodes 106, a threshold travel time, various deadline considerations, and so forth. In this example, node subset 108 only includes four candidate nodes 206.

Similar to the example of FIG. 2A, machine learning model 110 can select a candidate node 206 from node subset 108 to addition to the route 112. As shown, machine learning model 110 can select candidate node 206C despite the greater distance 204 in comparison to other candidate nodes 206. This decision can be based on a wide variety of factors. For instance, the deadline for reaching candidate node 206C may be earlier than the respective deadline for candidate node 206D. In another example, node subset 108 may indicate that despite a shorter distance 204 to reference node 202, travel time to candidate node 206D is much greater than candidate node 206C. Accordingly, the machine learning model 110 may select candidate node 206C to minimize travel time. As will be described further below, both optimization module 102 and machine learning model 110 can be configured with various factors and weights that emphasize or deemphasize those factors.

Turning now to FIG. 2C, the process as described above with respect to FIGS. 2A and 2B can be repeated for the full set of nodes 106 within problem space 104 to generate a full route 112. As this process goes on for the full set of nodes 106, optimization module 102 can maintain a record of nodes that have already been routed. In this way, optimization module 102 can ensure that the machine learning model only sees nodes 106 that have yet to be included in the route 112. In addition, optimization module 102 may determine that a route is complete once no additional nodes 106 remain to be routed. Alternatively, optimization module 102 can also detect that the route 112 has returned to the first reference node 202 shown here as starting node 208. This may accordingly inform the system 100 that the route 112 is complete. As will be discussed below, the route 112 may then be provided to a travelling entity for traversal. In a specific example, the route 112 may be generated by a logistics system for delivering packages and provided to one or several delivery vehicles to follow as they make their deliveries for the day.

As shown in FIG. 2D, a travelling entity 210 located at starting node 208 can begin to traverse the route 112 that was plotted according to the process as described above with respect to FIGS. 2A through 2C. In various examples, the travelling entity 210 may be a delivery vehicle that visits each node 106 to complete various deliveries. For instance, travelling entity 210 can be a delivery van that delivers packages to customers at their homes. In this example, individual nodes 106 can correspond to individual houses that are located around a city or county. In another example, travelling entity 210 can be a long-haul truck that delivers merchandise to various warehouses or wholesalers. Accordingly, the nodes 106 can represent the warehouses that are located around a geographic area such as multiple states or provinces. In addition, starting node 208 can correspond to a distribution hub for a logistics company or other location at which a travelling entity can originate such as a post office.

As the travelling entity 210 proceeds along the route, travelling entity 210 may be configured to report various aspects of the trip to optimization module 102. For instance, travelling entity 210 may report a current speed 212 alongside an average speed 214, as well as an elapsed time of travel 216. In addition, travelling entity 210 may also report a current position along the route 112. For instance, a current node 218 and next node 220 can inform optimization module 110 as to the current location of travelling entity 210. These and other factors can be aggregated as travel data 222 which can be communicated to optimization module 102 through a network connection. In some implementations, the travel data 222 can be included as part of the current state data 114. In addition, it should be understood that while the examples discussed herein generally involve a travelling entity 210 that is delivery vehicle traversing a geographic area, travelling entity 210 can be any entity that traverses a route 112. For instance, a route 112 may be plotted through a telecommunications network in which a travelling entity 210 can be a data packet that traverses the route 112.

In some configurations, the travelling entity 210 may traverse a predetermined route 112 as described above. Alternatively, the system 100 may dynamically plot the route 112 as travelling entity 210 sets of on its journey. In a specific example, the system 100 may be configured with a starting node 208 of travelling entity 210. Accordingly, the system 100 can select a next node 220 via the optimization module 102 and the machine learning model 110 as discussed above. As the travelling entity 210 proceeds to the next node 220 the optimization module 102 can utilize current state data 114 in conjunction with travel data 222 to select subsequent nodes 106 to include in route 112. In this way, the system 100 can flexibly adjust to changing conditions that may arise unexpectedly as travelling entity 210 moves around the problem space 104.

In a specific example, the travel data 222 may indicate that the current speed 212 and/or average speed 214 of travelling entity 210 has fallen below a threshold speed. Furthermore, current state data 114 may indicate unusually congested traffic between the starting node 208 and the next node 220 that affects travel time (e.g., due to a collision or inclement weather). Optimization module 102 may conclude that travelling to the next node 220 is suboptimal at the current time. Accordingly, the optimization module 102 may identify one or more alternative nodes 224 to include in an updated node subset 108 that rank higher than the current next node 220. The machine learning model 110 can then select an alternative node 224 that is then defined as the new next node 220. The system 100 can subsequently redirect travelling entity 210 to avoid the traffic jam and maintain a current speed 212 or average speed 214 that is above the expected threshold speed.

Proceeding now to FIG. 2E, additional aspects of the system 100 as applied to a problem space 104 are shown and described. In this example, a travelling entity 210 has begun traversing a route 112 as discussed above with respect to FIG. 2D. However, unlike the previous example, an unexpected change may arise during travel. In this instance, a priority deadline 226 may suddenly appear while the travelling entity 210 is located at the current node 218. In a specific instance, a customer who was scheduled to receive a delivery later in the day may suddenly require an urgent delivery. As such a priority deadline 226 can be generated and associated with a priority node 228. As will be discussed further below, a priority deadline 226 can enable the optimization module 102 to override the previous ranking of nodes 106 that generated the route 112.

As shown in FIG. 2E, the optimization module 102 and the machine learning model 110 can be configured to extract current state data 114 from the problem space 104. Current state data 114 can inform the optimization module 102 and/or the machine learning model 110 of the priority deadline 226 and the associated priority node 228. Accordingly, the optimization module 102 can assign the priority node 228 a maximum ranking relative to the other nodes 106. In this way, the optimization module 102 can ensure that the priority node 228 is seen by machine learning model 110. In addition, by providing the current state data 114 to the machine learning model 110, the system 100 can communicate the urgency of the priority deadline 226 and ensure that the machine learning model 110 selects the priority node for inclusion in a modified route 230. In this way, the system 100 can adapt to changing conditions in real-time.

Turning now to FIG. 2F, another example of adapting a modified route 230 to changing conditions of the problem space 104 is shown and described. As shown in FIG. 2F, a node 106 has been removed from the problem space 104. For instance, the removal of a node 106 may correspond to a customer cancelling a delivery with short notice. Accordingly, the removed node 232 can be reported to the optimization module 102 and/or the machine learning model 110 through the current state data 114. The optimization module 102 can analyze and rank nodes 106 that are near the current node 218 while omitting the removed node 232. Stated another way, the optimization module 102 can determine that a node has been removed and in response, exclude the removed node 232 from the node subset 108. This enables machine learning model 110 to generate a modified route 230 that ignores the removed node 232. Subsequently, the machine learning model 110 can select a next node 220 such that the modified route 230 does not include the removed node 232. As mentioned above, this approach enables the system 100 to quickly respond to a changing problem space 104 with a single iteration of the route calculation described above. In this way, only a portion of the route 112 is recalculated rather than the full route 112.

Proceeding now to FIG. 2G, the inverse of the example of FIG. 2F is shown and described. While FIG. 2F illustrated a removed node 232, this example illustrates an added node 234 that is added to problem space 104 while the travelling entity 210 is in transit at the current node 218. The current state data 114 can provide the location and status of the added node 234 to the optimization module 102 and/or the machine learning model 110. For instance, current state data 114 may also provide a deadline associated with the added node 234. By utilizing the current state data 114 to report changes to the topology of problem space 104, the optimization module 102 can react quickly and generate an updated node subset 108 to enable the machine learning model 110 to generate a modified route 230.

In this example, the travelling entity 210 was originally slated to travel to the next node 220 via the route 112. However, due to the location of the added node 234 in relation to the current node 218, the optimization module 102 may assign a rank to the added node 234 that is above the rank for the next node 220. As such, the machine learning model 110 may select the added node 234 as the next destination for the travelling entity 210. The added node 234 can then be accordingly defined as the next node 220 for the modified route 230.

In other examples, the added node 234 may be located away from the current node 218 (e.g., further along the route). As such, the associated ranking assigned by the optimization module 102 may be lower than other nodes 106. Accordingly, the added node 234 may not be included in the node subset 108 that is provided to the machine learning model 110. In this instance, the modified route 230 may not be generated immediately in response to the added node 234, but rather at a later time as the travelling entity 210 nears the added node 234. Alternatively, the added node 234 may include an associated priority deadline 226 such as the example discussed with respect to FIG. 2E. In this example, the added node 234 may receive a high ranking from the optimization module 102 to ensure that a travelling entity 210 reaches the new node 234 promptly.

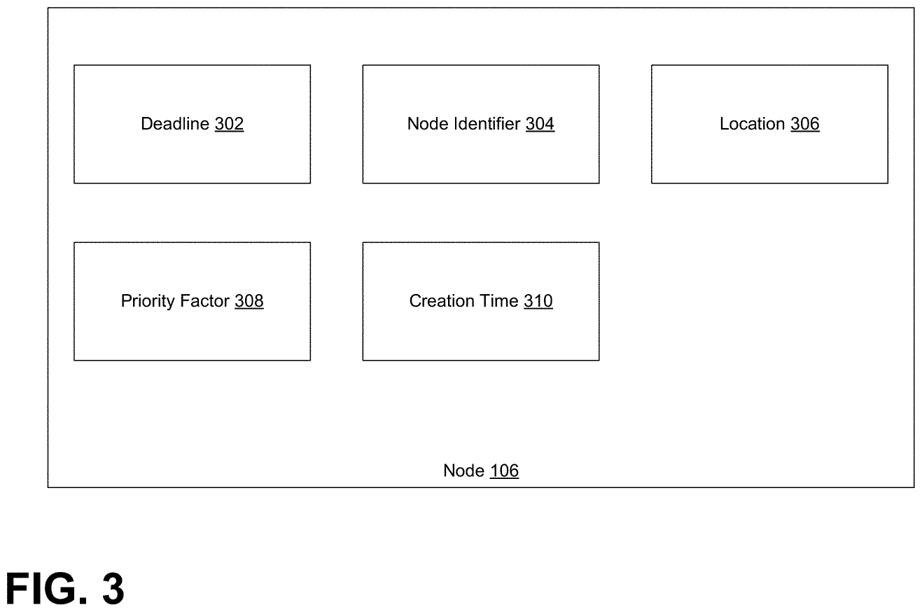

Turning now to FIG. 3, aspects of an individual node 106 are shown and described. As mentioned above, a node 106 can include a deadline 302 that defines a time in which the node 106 is to be serviced by the system 100. In various examples, the deadline 302 can be a time window (e.g., 3-5 PM) or a specific time (e.g., 11:30 AM). For instance, in the context of a logistics company the deadline 302 may be a delivery time at which a travelling entity 210 (e.g., a delivery truck) must arrive. In another example, the deadline can be a required time of arrival for a data packet in a telecommunications network. Each node 106 can also include a node identifier to distinguish an individual node 106 from others. The node identifier 304 can utilize any suitable method to name each node 106 such as a customer name, serial number, unique hash value, and so forth. Various deadlines 302 can be provided to the optimization module 102 along with the node identifier 304 to inform the generation of the ranked list as mentioned above. It should be understood that while the examples discussed herein involve real-world times, the deadline 302 can be defined using any suitable measurement of time such as real-world time, processor cycles, and the like.

In addition, each node 106 can include a location 306 which defines the position of the node 106 within the problem space 104. In some implementations, the location 306 can be a set of coordinates that denotes a geographic location such as the nodes shown and described with respect to FIG. 2A through 2G. In other examples, the location 306 can be a digital address to identify a computing device within a network such as an IP address. Various locations 306 can be analyzed by the optimization module 102 to inform the ranking of nodes 106. Similarly, each node can include a priority factor 308 that indicates a level of importance for a particular node 106. In various examples, the priority factor can be a numerical score that is calculated by the optimization module 102 and assigned to each respective node. As will be discussed further below, the priority factor 308 can be calculated by the optimization module 102 and accordingly assigned to each node 106 for subsequent ranking. Finally, each node 106 can include a creation time 310 that indicates a when a node 106 was added to the problem space 104. For instance, the added node 234 may have a later creation time 310 in comparison to the starting node 208. In various examples, the creation time 310 may also influence the calculation of the priority factor 308. For example, a node 106 with an earlier creation time 310 may receive a higher priority factor 308 in relation to a node 106 with a later creation time 310, given similar deadlines 302 or other factors. As with deadline 302, creation time 310 can utilize and suitable measure of time.

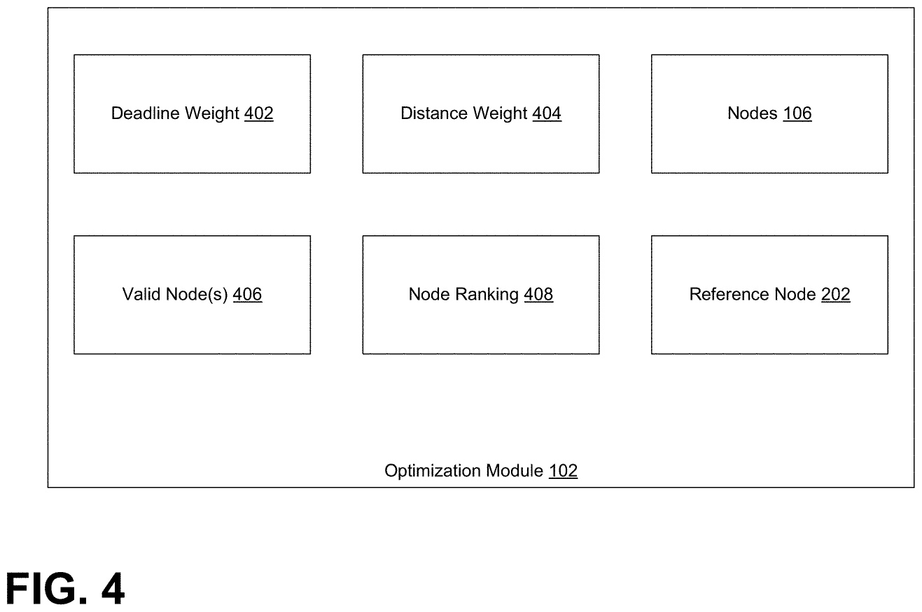

Proceeding now to FIG. 4, aspects of the optimization module 102 are shown and described. As described above, the optimization module 102 can analyze nodes 106 of a problem space 104 and rank the nodes 106 to select a node subset 108 for processing by a machine learning model 110. To generate the node subset 108, the optimization module 102 can consider deadlines 302, locations 306, among other factors. For example, the optimization module 102 can be configured with a deadline weight 402 as well as a distance weight 404 which can serve to emphasize or deemphasize each respective factor when calculating an overall priority factor 308 for each node. In a specific example, the optimization module 102 may be configured to prioritize deadlines 302 even in the event that a travelling entity 210 must traverse longer distances. In this way, the system 100 can generate a route 112 that reaches nodes 106 with an earlier deadline 302 first. Alternatively, the optimization module 102 may be configured to prioritize distance which is calculated based on the location 306 of each node 106 relative. This enables the system 100 to calculate a route 112 that is optimized for travel distance. In addition, the deadline weight 402 and the distance weight 404 can be fine-tuned to strike a balance between each factor. In some configurations, the deadline weight 402 and the distance weight 404 can be adjusted automatically by the system 100 based on previous routes 112 as well as current state data 114 and travel data 222. Alternatively, the deadline weight 402 and the distance weight 404 can be manually adjusted by an administrative entity such as a system engineer.

In some configurations, disparate factors can be aggregated to determine values for deadline weight 402 and/or distance weight 404. For instance, a logistics company may wish to cut operating costs by reducing fuel consumption. The system 100 can thus be configured with a desired level of fuel consumption. Based on current state data 114 and/or travel data extracted from the travelling entities 210, the optimization module 102 can calculate a corresponding distance weight 404 to minimize distance travelled and achieve fuel consumption goals. In another example, the logistics company can aim to reduce stress on delivery drivers by providing more forgiving deadlines 302. Accordingly, the deadline weight 402 can be adjusted to reduce the emphasis on achieving deadlines 302 while the distance weight 404 can be modified such that routes 112 tend to avoid traffic rather than minimize distance travelled.

The optimization module 102 can also track which nodes 106 have not yet been routed using a list of valid nodes 406. In various examples, all nodes 106 with the exception of a starting node 208 are valid for inclusion in the node subset 108. As various nodes 106 are added to the route 112, they can be accordingly removed from the list of valid nodes 406. In addition, optimization module 102 may be configured to only consider nodes 106 that are present in the list of valid nodes 406 for inclusion in the node ranking 408. As mentioned above, this enables the system 100 to handle constraints associated with the travelling salesperson problem in which the same node cannot be routed more than once.

In addition, the optimization module 102 can calculate a priority factor 308 for each of the valid nodes 406 which can then be ranked according to their respective priority factors 310. Furthermore, the optimization module 102 can select a node subset 108 from the node ranking 408 for processing by the machine learning model 110. As discussed above, the node subset 108 can be a predefined number of nodes 106 or a dynamic number of nodes 106 that is determined by the optimization module 102.

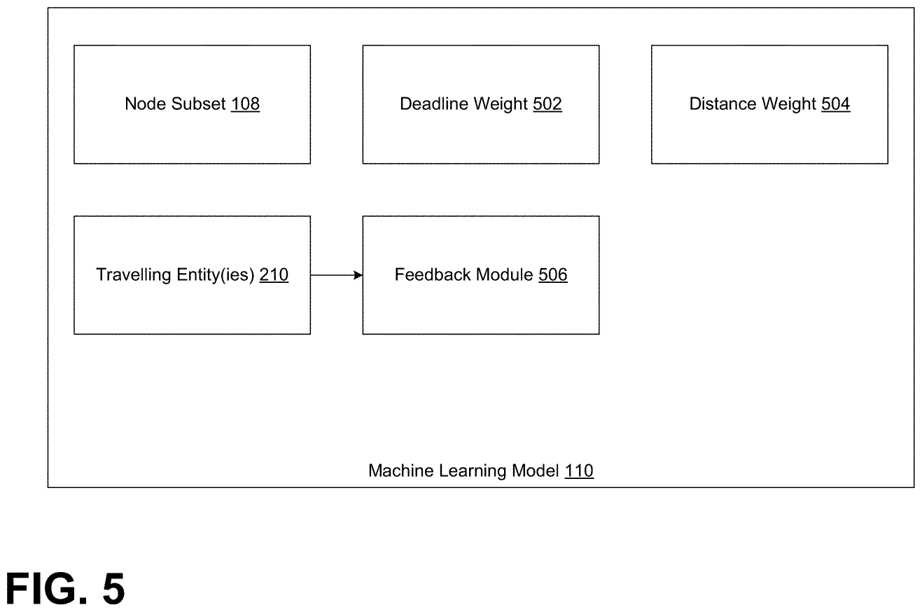

Turning now to FIG. 5, aspects of the machine learning model 110 are shown and described. As described above, the machine learning model 110 can receive a node subset 108 from the optimization module 102 for processing. In some configurations, the machine learning model 110 can select the highest ranked node 106 among the node subset 108. In other examples, the machine learning model 110 can be configured to calculate a total cost of the route 112 to reflect various factors of the node subset 108 when selecting nodes for the final route 112. For example, a total cost may be a weighted combination of various factors such as travel time, total distance, missed deadlines, and the like. As mentioned above, the machine learning model 110 can be trained to understand the impact of various routing decisions on the total cost and aim to strike a realistic balance of factors in the total cost.

When analyzing the node subset 108, the machine learning model 110 can extract various information discussed above with respect to FIG. 3 such as deadlines 302, locations 306, and the like. As with the optimization module, the machine learning model 110 can also be configured with a deadline weight 502 and a distance weight 504 to emphasize or deemphasize various factors when plotting a route 112. In some configurations deadline weight 502 and distance weight 504 can be identical to the deadline weight 402 and the distance weight 404 for optimization module 102. However, in other implementations the deadline weight 502 and the distance weight 504 of machine learning model 110 can be configured independently of the deadline weight 404 and the distance weight 404 of the optimization module. For example, prioritizing distance may prove to be more optimal when ranking and selecting nodes 106 for the node subset 108 while prioritizing deadlines 302 can be more optimal when selecting individual nodes 106 for the route 112.

In addition, the machine learning model 110 can keep track of various travelling entities 210 that traverse the route 112. For example, a travelling entity 210 can be a delivery vehicle that travels to various cities. In other examples, the travelling entity 210 can be a data packet within a telecommunications network. As discussed above, the machine learning model 110 can extract travel data 222 from the travelling entity 210 which can be processed using the feedback module 506. In various examples, feedback module 506 can be configured to analyze travel data 222 as well as current state data 114 among other feedback to determine an optimality of a route 112. For instance, in the context of reinforcement learning, the feedback module 506 may calculate a perceived cumulative reward to represent the overall optimality of a route 112. This cumulative reward can be related to the total cost mentioned above. For instance, the cumulative reward can increase as the machine learning model reduces the total cost of the route 112. Accordingly, machine learning model 110 can be configured to seek a maximum level of cumulative reward and thus select nodes 106 that tend to increase the level of perceived cumulative reward. In this way, the system 100 can improve the quality of routes 112 over time and provide highly customized solutions for each application or deployment.

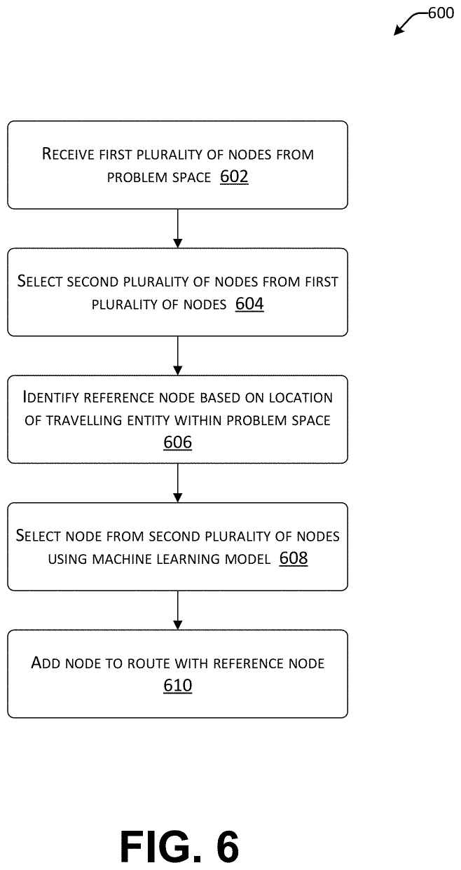

Turning now to FIG. 6, aspects of a routine for enabling routing problem solving through machine learning and optimization modules are shown and described. For ease of understanding, the processes discussed in this disclosure are delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 600 are described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routine 600 may be also implemented in many other ways. For example, the routine 600 may be implemented, at least in part, by a processor of another remote computer or a local circuit. In addition, one or more of the operations of the routine 600 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

With reference to FIG. 6, routine 600 begins at operation 602 where a system receives a first plurality of nodes from a problem space.

Next at operation 604, the system selects a second plurality of nodes from the first plurality of nodes.

Proceeding to operation 606, the system identifies a reference node based on a location of a travelling entity within the problem space.

At operation 608, a machine learning model selects a node from the second plurality of nodes based on a relation between the selected node and the reference node.

Finally, at operation 610, the selected node is added to a route along with the reference node.

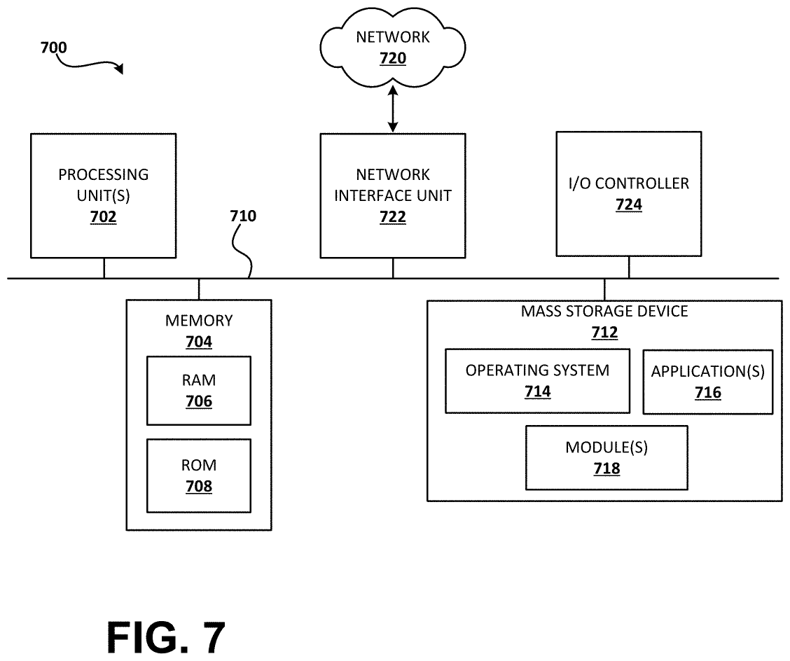

FIG. 7 shows additional details of an example computer architecture 700 for a device, such as a computer or a server configured as part of the cloud-based platform or system 100, capable of executing computer instructions (e.g., a module or a program component described herein). The computer architecture 700 illustrated in FIG. 7 includes processing unit(s) 702, a system memory 704, including a random-access memory 706 (“RAM”) and a read-only memory (“ROM”) 708, and a system bus 710 that couples the memory 704 to the processing unit(s) 702.

Processing unit(s), such as processing unit(s) 702, can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 700, such as during startup, is stored in the ROM 708. The computer architecture 700 further includes a mass storage device 712 for storing an operating system 714, application(s) 716, modules 718, and other data described herein.

The mass storage device 712 is connected to processing unit(s) 702 through a mass storage controller connected to the bus 710. The mass storage device 712 and its associated computer-readable media provide non-volatile storage for the computer architecture 700. Although the description of computer-readable media contained herein refers to a mass storage device, it should be appreciated by those skilled in the art that computer-readable media can be any available computer-readable storage media or communication media that can be accessed by the computer architecture 700.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 700 may operate in a networked environment using logical connections to remote computers through the network 720. The computer architecture 700 may connect to the network 720 through a network interface unit 722 connected to the bus 710. The computer architecture 700 also may include an input/output controller 724 for receiving and processing input from a number of other devices, including a keyboard, mouse, touch, or electronic stylus or pen. Similarly, the input/output controller 824 may provide output to a display screen, a printer, or other type of output device.

It should be appreciated that the software components described herein may, when loaded into the processing unit(s) 702 and executed, transform the processing unit(s) 702 and the overall computer architecture 700 from a general-purpose computing system into a special-purpose computing system customized to facilitate the functionality presented herein. The processing unit(s) 702 may be constructed from any number of transistors or other discrete circuit elements, which may individually or collectively assume any number of states. More specifically, the processing unit(s) 702 may operate as a finite-state machine, in response to executable instructions contained within the software modules disclosed herein. These computer-executable instructions may transform the processing unit(s) 702 by specifying how the processing unit(s) 702 transition between states, thereby transforming the transistors or other discrete hardware elements constituting the processing unit(s) 702.

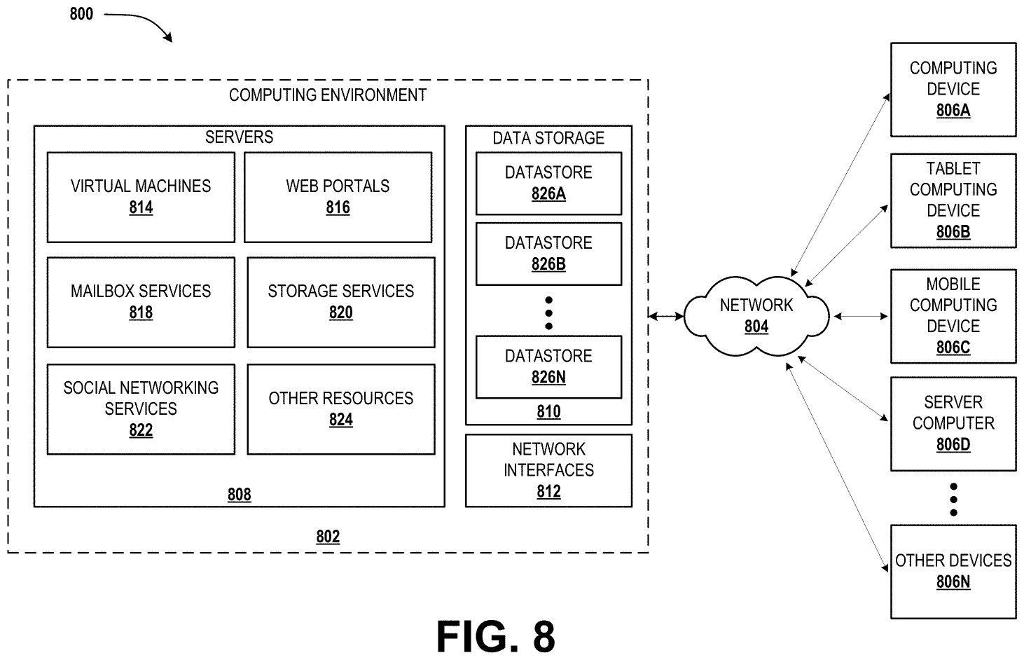

FIG. 8 depicts an illustrative distributed computing environment 800 capable of executing the software components described herein. Thus, the distributed computing environment 800 illustrated in FIG. 8 can be utilized to execute any aspects of the software components presented herein. For example, the distributed computing environment 800 can be utilized to execute aspects of the software components described herein.

Accordingly, the distributed computing environment 800 can include a computing environment 802 operating on, in communication with, or as part of the network 804. The network 804 can include various access networks. One or more client devices 806A-806N (hereinafter referred to collectively and/or generically as “clients 806” and also referred to herein as computing devices 806) can communicate with the computing environment 802 via the network 804. In one illustrated configuration, the clients 806 include a computing device 806A such as a laptop computer, a desktop computer, or other computing device; a slate or tablet computing device (“tablet computing device”) 806B; a mobile computing device 806C such as a mobile telephone, a smart phone, or other mobile computing device; a server computer 806D; and/or other devices 806N. It should be understood that any number of clients 806 can communicate with the computing environment 802.

In various examples, the computing environment 802 includes servers 808, data storage 810, and one or more network interfaces 812. The servers 808 can host various services, virtual machines, portals, and/or other resources. In the illustrated configuration, the servers 808 host virtual machines 814, Web portals 816, mailbox services 818, storage services 820, and/or, social networking services 822. As shown in FIG. 8 the servers 808 also can host other services, applications, portals, and/or other resources (“other resources”) 824.

As mentioned above, the computing environment 802 can include the data storage 810. According to various implementations, the functionality of the data storage 810 is provided by one or more databases operating on, or in communication with, the network 804. The functionality of the data storage 810 also can be provided by one or more servers configured to host data for the computing environment 802. The data storage 810 can include, host, or provide one or more real or virtual datastores 826A-826N (hereinafter referred to collectively and/or generically as “datastores 826”). The datastores 826 are configured to host data used or created by the servers 808 and/or other data. That is, the datastores 826 also can host or store web page documents, word documents, presentation documents, data structures, algorithms for execution by a recommendation engine, and/or other data utilized by any application program. Aspects of the datastores 826 may be associated with a service for storing files.

The computing environment 802 can communicate with, or be accessed by, the network interfaces 812. The network interfaces 812 can include various types of network hardware and software for supporting communications between two or more computing devices including, but not limited to, the computing devices and the servers. It should be appreciated that the network interfaces 812 also may be utilized to connect to other types of networks and/or computer systems.

It should be understood that the distributed computing environment 800 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 800 provides the software functionality described herein as a service to the computing devices. It should be understood that the computing devices can include real or virtual machines including, but not limited to, server computers, web servers, personal computers, mobile computing devices, smart phones, and/or other devices. As such, various configurations of the concepts and technologies disclosed herein enable any device configured to access the distributed computing environment 800 to utilize the functionality described herein for providing the techniques disclosed herein, among other aspects.

The disclosure presented herein also encompasses the subject matter set forth in the following clauses.

Example Clause A, a method comprising: receiving a first plurality of nodes from a problem space; selecting, by one or more processing units, a second plurality of nodes from the first plurality of nodes, wherein the second plurality of nodes comprises a number of nodes that is less than a number of nodes in the first plurality of nodes; identifying a reference node based on a current location of a traveling entity within the problem space; selecting, using a machine learning model, a node from the second plurality of nodes based on a relation between the selected node and the reference node within the problem space; and adding the selected node to a route comprising at least the reference node.

Example Clause B, the method of Example Clause A, wherein an individual node in the first plurality of nodes comprises a corresponding physical location.

Example Clause C, the method of Example Clause A or Example Clause B, wherein an individual node in the first plurality of nodes includes a deadline defining a required time of arrival.

Example Clause D, the method of any one of Example Clauses A through C, wherein the second plurality of nodes are selected based on a distance between the reference node and each node in the second plurality of nodes.

Example Clause E, the method of any one of Example Clauses A through D, wherein the route is further calculated based on a time of travel between the reference node and each node in the second plurality of nodes.

Example Clause F, the method of any one of Example Clauses A through E, further comprising: establishing one or more weights for the machine learning model to emphasize or deemphasize a distance or a travel time between each pair of nodes in the second plurality of nodes; and calculating, by the machine learning model, the route based at least in part on the one or more weights.

Example Clause G, the method of any one of Example Clauses A through F, further comprising: detecting a node that is added to, or removed from, the first plurality of nodes resulting in a changed first plurality of nodes; and in response to detecting the node, selecting a third plurality of nodes from the changed first plurality of nodes, wherein the third plurality of nodes is different than the second plurality of nodes.

Example Clause H, the method of any one of Example Clauses A through G, further comprising: calculating a priority factor for each of the first plurality of nodes based on a deadline of the node and a position of the node within the problem space; ranking the first plurality of nodes based on the priority factors calculated for the first plurality of nodes; and selecting the second plurality of nodes based on the ranking of the first plurality of nodes.

Example Clause I, a system comprising: one or more processing units; and a computer-readable medium having encoded thereon computer-readable instructions that when executed cause the one or more processing units to: receive a first plurality of nodes from a problem space; select a second plurality of nodes from the first plurality of nodes, wherein the second plurality of nodes comprises a number of nodes that is less than a number of nodes in the first plurality of nodes; identify a reference node based on a current location of a traveling entity within the problem space; select, using a machine learning model, a node from the second plurality of nodes based on a relation between the selected node and the reference node within the problem space; and add the selected node to a route comprising at least the reference node.

Example Clause J, the system of Example Clause I, wherein an individual node in the first plurality of nodes comprises a corresponding physical location.

Example Clause K, the system of Example Clause I or Example Clause J, wherein an individual node in the first plurality of nodes includes a deadline defining a required time of arrival.

Example Clause L, the system of any one of Example Clauses I through K, wherein the second plurality of nodes are selected based on a distance between the reference node and each node in the second plurality of nodes.

Example Clause M, the system of any one of Example Clauses I through L, wherein the computer-readable instructions further cause the one or more processing units to: establish one or more weights for the machine learning model to emphasize or deemphasize a distance or a travel time between each pair of nodes in the second plurality of nodes; and calculate, by the machine learning model, the route based at least in part on the one or more weights.

Example Clause N, the system of any one of Example Clauses I through M, wherein the computer-readable instructions further cause the one or more processing units to: detect a node that is added to, or removed from, the first plurality of nodes resulting in a changed first plurality of nodes; and in response to detecting the node, select a third plurality of nodes from the changed first plurality of nodes, wherein the third plurality of nodes is different than the second plurality of nodes.

Example Clause O, the system of any one of Example Clauses I through N, wherein the computer-readable instructions further cause the one or more processing units to: calculate a priority factor for each of the first plurality of nodes based on a deadline of the node and a position of the node within the problem space; rank the first plurality of nodes based on the priority factors calculated for the first plurality of nodes; and select the second plurality of nodes based on the ranking of the first plurality of nodes.

Example Clause P, a computer-readable storage medium, having encoded thereon that when executed by one or more processing units, cause a system to: receive a first plurality of nodes from a problem space; select a second plurality of nodes from the first plurality of nodes, wherein the second plurality of nodes comprises a number of nodes that is less than a number of nodes in the first plurality of nodes; identify a reference node based on a current location of a traveling entity within the problem space; select, using a machine learning model, a node from the second plurality of nodes based on a relation between the selected node and the reference node within the problem space; and add the selected node to a route comprising at least the reference node.

Example Clause Q, the computer-readable storage medium of Example Clause P, wherein the second plurality of nodes are selected based on a distance between the reference node and each node in the second plurality of nodes.

Example Clause R, the computer-readable storage medium of Example Clause P or Example Clause Q, wherein the computer-readable instructions further cause the system to: establish one or more weights for the machine learning model to emphasize or deemphasize a distance or a travel time between each pair of nodes in the second plurality of nodes; and calculate, by the machine learning model, the route based at least in part on the one or more weights.

Example Clause S, the computer-readable storage medium of any one of Example Clauses P through R, wherein the computer-readable instructions further cause the system to: detect a node that is added to, or removed from, the first plurality of nodes resulting in a changed first plurality of nodes; and in response to detecting the node, select a third plurality of nodes from the changed first plurality of nodes, wherein the third plurality of nodes is different than the second plurality of nodes.

Example Clause T, the computer-readable storage medium of any one of Example Clauses P through S, wherein the computer-readable instructions further cause the system to: calculate a priority factor for each of the first plurality of nodes based on a deadline of the node and a position of the node within the problem space; rank the first plurality of nodes based on the priority factors calculated for the first plurality of nodes; and select the second plurality of nodes based on the ranking of the first plurality of nodes.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element (e.g., two different nodes).

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method comprising:
receiving a first plurality of nodes from a problem space;
selecting, by one or more processing units, a second plurality of nodes from the first plurality of nodes, wherein the second plurality of nodes comprises a number of nodes that is less than a number of nodes in the first plurality of nodes;
identifying a reference node based on a current location of a traveling entity within the problem space;
selecting, using a machine learning model, a node from the second plurality of nodes based on a relation between the selected node and the reference node within the problem space; and
adding the selected node to a route comprising at least the reference node.

2. The method of claim 1, wherein an individual node in the first plurality of nodes comprises a corresponding physical location.

3. The method of claim 1, wherein an individual node in the first plurality of nodes includes a deadline defining a required time of arrival.

4. The method of claim 1, wherein the second plurality of nodes are selected based on a distance between the reference node and each node in the second plurality of nodes.

5. The method of claim 1, wherein the route is further calculated based on a time of travel between the reference node and each node in the second plurality of nodes.

6. The method of claim 1, further comprising:
establishing one or more weights for the machine learning model to emphasize or deemphasize a distance or a travel time between each pair of nodes in the second plurality of nodes; and
calculating, by the machine learning model, the route based at least in part on the one or more weights.

7. The method of claim 1, further comprising:
detecting a node that is added to, or removed from, the first plurality of nodes resulting in a changed first plurality of nodes; and
in response to detecting the node, selecting a third plurality of nodes from the changed first plurality of nodes, wherein the third plurality of nodes is different than the second plurality of nodes.

8. The method of claim 1, further comprising:
calculating a priority factor for each of the first plurality of nodes based on a deadline of the node and a position of the node within the problem space;
ranking the first plurality of nodes based on the priority factors calculated for the first plurality of nodes; and
selecting the second plurality of nodes based on the ranking of the first plurality of nodes.

9. A system comprising:
one or more processing units; and
a computer-readable medium having encoded thereon computer-readable instructions that when executed cause the one or more processing units to:
receive a first plurality of nodes from a problem space;
select a second plurality of nodes from the first plurality of nodes, wherein the second plurality of nodes comprises a number of nodes that is less than a number of nodes in the first plurality of nodes;
identify a reference node based on a current location of a traveling entity within the problem space;
select, using a machine learning model, a node from the second plurality of nodes based on a relation between the selected node and the reference node within the problem space; and
add the selected node to a route comprising at least the reference node.

10. The system of claim 9, wherein an individual node in the first plurality of nodes comprises a corresponding physical location.

11. The system of claim 9, wherein an individual node in the first plurality of nodes includes a deadline defining a required time of arrival.

12. The system of claim 9, wherein the second plurality of nodes are selected based on a distance between the reference node and each node in the second plurality of nodes.

13. The system of claim 9, wherein the computer-readable instructions further cause the one or more processing units to:
establish one or more weights for the machine learning model to emphasize or deemphasize a distance or a travel time between each pair of nodes in the second plurality of nodes; and
calculate, by the machine learning model, the route based at least in part on the one or more weights.

14. The system of claim 9, wherein the computer-readable instructions further cause the one or more processing units to:
detect a node that is added to, or removed from, the first plurality of nodes resulting in a changed first plurality of nodes; and
in response to detecting the node, select a third plurality of nodes from the changed first plurality of nodes, wherein the third plurality of nodes is different than the second plurality of nodes.

15. The system of claim 9, wherein the computer-readable instructions further cause the one or more processing units to:
calculate a priority factor for each of the first plurality of nodes based on a deadline of the node and a position of the node within the problem space;
rank the first plurality of nodes based on the priority factors calculated for the first plurality of nodes; and
select the second plurality of nodes based on the ranking of the first plurality of nodes.

16. A computer-readable storage medium, having encoded thereon that when executed by one or more processing units, cause a system to:
receive a first plurality of nodes from a problem space;
select a second plurality of nodes from the first plurality of nodes, wherein the second plurality of nodes comprises a number of nodes that is less than a number of nodes in the first plurality of nodes;
identify a reference node based on a current location of a traveling entity within the problem space;
select, using a machine learning model, a node from the second plurality of nodes based on a relation between the selected node and the reference node within the problem space; and
add the selected node to a route comprising at least the reference node.

17. The computer-readable storage medium of claim 16, wherein the second plurality of nodes are selected based on a distance between the reference node and each node in the second plurality of nodes.

18. The computer-readable storage medium of claim 16, wherein the computer-readable instructions further cause the system to:
establish one or more weights for the machine learning model to emphasize or deemphasize a distance or a travel time between each pair of nodes in the second plurality of nodes; and
calculate, by the machine learning model, the route based at least in part on the one or more weights.

19. The computer-readable storage medium of claim 16, wherein the computer-readable instructions further cause the system to:
detect a node that is added to, or removed from, the first plurality of nodes resulting in a changed first plurality of nodes; and
in response to detecting the node, select a third plurality of nodes from the changed first plurality of nodes, wherein the third plurality of nodes is different than the second plurality of nodes.

20. The computer-readable storage medium of claim 16, wherein the computer-readable instructions further cause the system to:
calculate a priority factor for each of the first plurality of nodes based on a deadline of the node and a position of the node within the problem space;
rank the first plurality of nodes based on the priority factors calculated for the first plurality of nodes; and
select the second plurality of nodes based on the ranking of the first plurality of nodes.
